(19) United States
(12) Patent Application Publication
(10) Pub. No.: US 2025/0015535 A1
(43) Pub. Date: Jan. 9, 2025

(54) MALE SINGLE-PIN CONNECTOR, FEMALE MULTI-PIN CONNECTOR AND CONNECTOR SYSTEM FORMEDT HEREOF

(71) Applicant: HARTING ELECTRIC STIFTUNG & CO. KG, Espelkamp (DE)

(72) Inventors: Chuan Sheng DING, Zhuhai (CN); Shao Wei WEN, Zhuhai (CN); Denny HELLIGE, Bad Oeynhausen (DE)

(21) Appl. No.: 18/707,126

(22) PCT Filed: Oct. 24, 2022
(86) PCT No.: PCT/DE2022/100783

§ 371 Date: May 2, 2024

(30) Foreign Application Priority Data
Nov. 3, 2021 (CN) 202111293313.7

(51) Int. Cl. H01R 13/622

(52) U.S. Cl. CPC H01R 13/622

(57) ABSTRACT

A male single-pin connector is provided. The single-pin connector includes a contact, which has a contact housing, wherein the contact housing has at least one limiting protrusion on an outer surface; and a cover for receiving the contact, wherein the inner surface of the cover has an inwardly protruding limiting portion and an internal thread portion, wherein the internal thread portion is closer to the insertion side than the limiting portion; wherein the male single-pin connector also includes a retaining ring having an outer thread portion, wherein, after insertion of the contact housing into the cover against the plug-in direction, the retaining ring is screwed into the cover until the limiting protrusion comes into contact with the limiting portion, thereby fixing the contact housing in the cover by a screw connection. A female multi-pin connector and a connector system is also provided. A simple securing of the contact can be achieved using the male single-pin connector and the female multi-pin connector. An independent mounting or removal of the male single-pin connector can be achieved using the connector system, which facilitates assembly.

### BACKGROUND

### Technical Field

The present disclosure relates to the technical field of connectors, such as a single-pin connector, a multi-pin connector, and a connector system including the single-pin connector and the multi-pin connector.

### Description of the Related Art

In the field of rail vehicles, connector systems are widely used to transmit high electrical currents. In detail, they are used, for example, to create an electrical or signaling connection between two train compartments. In practical use, such a connector system usually has a high weight and large dimensions, hindering on-site installation by an engineer.

### BRIEF SUMMARY

Embodiments of the disclosure provide a single-pin connector and a multi-pin connector in which a contact is inserted and removed by a retaining ring, which simplifies construction and facilitates maintenance and exchange of the contact. The present disclosure is furthermore based on providing a connector system including the above-described single-pin connector and multi-pin connector, using which a single-pin connector can be inserted in or removed from the multi-pin connector independently, facilitating on-site installation of the connector system.

In an embodiment, a single-pin connector is provided. The single-pin connector has a plug side for assembly with a counter-connector, and a connection side for connection of a cable, and includes: a contact which has a contact housing, wherein the contact housing has at least one delimiting protrusion on an outer surface; and a cover for receiving the contact, wherein the inner surface of the cover has an inwardly protruding delimiting portion and an internal thread portion, wherein the internal thread portion is closer to the plug side than the delimiting portion; wherein the single-pin connector further includes a retaining ring having an external thread portion, wherein, after insertion of the contact housing into the cover against the plug-in direction, the retaining ring is screwed into the cover until the delimiting protrusion bears against the delimiting portion, thereby fixing the contact housing in the cover by a screw connection.

In an embodiment, the retaining ring may be cylindrical, wherein a plurality of notches are provided on one side of the retaining ring in order to come into engagement with a tool for screwing in the retaining ring; wherein an inwardly protruding flange is arranged on the other side of the retaining ring in order to bear against the delimiting protrusion; wherein the external thread portion is arranged between the notches and the flange on the outer circumference of the retaining ring.

In an embodiment, the cover may include a cover insertion portion, a grip and a flange portion which is arranged between the cover insertion portion and the grip.

In an embodiment, the inner face of the flange portion region may include the delimiting portion and the internal thread portion, wherein the delimiting portion is formed as a step portion and the end face of the step portion forms a delimiting face, or alternatively the delimiting portion is configured as a lug, wherein a side of the lug forms a delimiting face, wherein the distance between the internal thread portion and the delimiting face is greater than or equal to the width of the delimiting protrusion.

In an embodiment, the inner face of the flange portion region may include an additional step portion arranged between the delimiting portion and the internal thread portion, wherein the inner diameter of the delimiting portion is smaller than the inner diameter of the additional step portion, and the inner diameter of the additional step portion is smaller than the inner diameter of the internal thread portion.

In an embodiment, the additional step portion may be rounded so as to adapt to the outer form of the flange of the retaining ring.

In an embodiment, the flange portion may be square or rectangular, wherein in the corners of the flange portion, two diagonally arranged coding pin holes and two diagonally arranged threaded holes are provided for receiving coding pins and locking elements respectively. Alternatively, in another embodiment, the outer contour of the cover insertion portion may be square or rectangular, wherein in the corners of the cover insertion portion, two diagonally arranged coding pin holes and two diagonally arranged threaded holes are provided for receiving coding pins and locking elements respectively; wherein the inner contour of the cover insertion portion is cylindrical.

In another embodiment, a multi-pin connector is provided. The multi-pin connector may include a passage housing which has at least one opening and a plurality of sockets arranged at the opening; and a plurality of contacts, wherein each contact has at least one delimiting protrusion on the outer face; the inner face of the socket has an inwardly protruding delimiting portion and an internal thread portion, wherein the multi-pin connector has several retaining rings, each with an external thread portion, wherein after insertion of the contact in the socket against the plug-in direction, the retaining ring is screwed into the sockets until the delimiting protrusion bears against the delimiting portion, whereby the contact is fixed in the socket by a screw connection.

In another embodiment, a connector system is provided. The connector system may include a plurality of single-pin connectors and the multi-pin connector, wherein the several single-pin connectors can be inserted in their corresponding sockets independently of one another.

In an embodiment, the single-pin connector may be a male connector and the multi-pin connector may be a female connector, or vice versa.

The single-pin connector, the multi-pin connector and the connector system described herein meet the requirements for testing with respect to insulation resistance (test at R₁≥10¹⁰Ω), dielectric strength (test at 18 kV), the IPX8 test (water- and dust-tightness) (no water penetration under test conditions over a period of 16 hours), a derating test, and no contact interference of ≥1 μs occurs during a vibration/oscillation test.

### BRIEF DESCRIPTION OF THE SEVERAL VIEWS OF THE DRAWINGS

Embodiments of the disclosure are illustrated in the drawings and explained in more detail below.

FIG. 1 shows a single-pin connector in a three-dimensional illustration.

FIG. 2 shows the single-pin connector in an exploded view.

FIG. 3 shows a top view of the single-pin connector.

FIG. 4 shows the single-pin connector in a sectional view.

FIG. 5 shows a connector system in a three-dimensional illustration.

FIG. 6 shows the connector system in the view from below.

FIG. 7 shows the connector system in an exploded view.

FIG. 8 shows a multi-pin connector in an exploded view.

FIG. 9 shows the multi-pin connector in a three-dimensional illustration.

FIG. 10 shows the multi-pin connector in a view from below.

### DETAILED DESCRIPTION

Embodiments of the present disclosure are described in more detail below with reference to embodiments shown in appended drawings. In the description, the same or similar reference signs apply to the same or similar parts. The description below of the embodiments with reference to the appended drawings, serves to present the fundamental principle of the present disclosure and should not be regarded as a limitation of the present disclosure.

In the present disclosure, the directional terms “front” and “back” are defined in relation to the plug-in direction. It should be noted that the plug-in directions of the plug connector and socket connector described herein run opposite one another. The terms “inner” and “outer” are defined in relation to the radial direction of the single-pin connector/socket. The terms “inward” and “outward” relate to a direction facing radially towards the axis and radially away from the axis respectively.

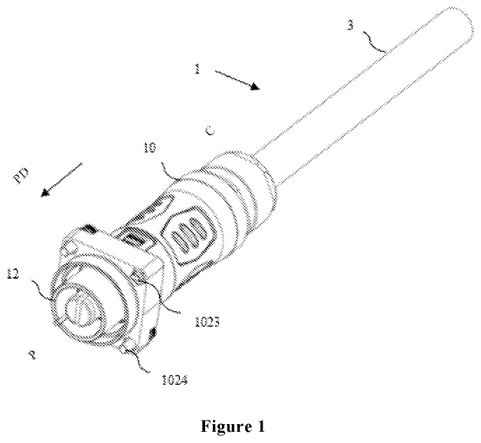

FIG. 1 shows a single-pin connector 1. The term “single-pin” here means that this is an individual connector. The single-pin connector 1 serves to transmit a high electrical current, e.g., 650 Ampere. The single-pin connector 1 is configured as a male connector and comprises mainly a cover 10 and a contact received in the cover (male contact in this case). The single-pin connector 1 has a plug side P for assembly with a counter-connector 2 (namely the multi-pin connector) (FIG. 5); and a connection side C for connection of a cable 3.

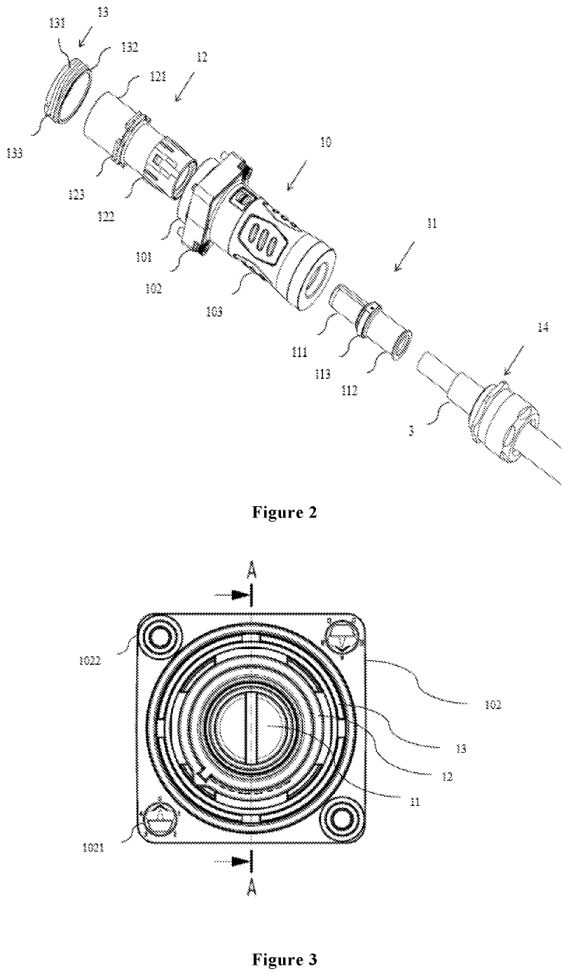

As shown in FIG. 2, the contact is substantially cylindrical and consists of two parts, namely a terminal 11 and a contact housing 12 receiving the terminal 11. Viewed from the plug-in direction PD, the terminal 11 has, in this order, a terminal insertion portion 111 and a terminal connection portion 112. An annular flange 113 is provided at the connecting point between the terminal insertion portion 111 and the terminal connecting portion 112. The contact housing 12 is an insulating housing and, viewed from the plug-in direction PD, has in this order a contact housing insertion portion 121 and a contact housing connecting portion 122. At least one delimiting protrusion 123 is provided on an outer face of the contact housing 12 at the connecting point between the contact housing insertion portion 121 and the contact housing connecting portion 122. The outer face may have two, four or another number of delimiting protrusions arranged rotationally symmetrically. Alternatively, the delimiting protrusion is annular.

The cover 10 is also substantially cylindrical and, viewed from the plug-in direction PD, has in this order a cover insertion portion 101, a flange portion 102 and a grip 103. The cover insertion portion 101 is cylindrical and may alternatively be square or rectangular. The flange portion 102 is square or rectangular. At its corners, two diagonally arranged coding pin holes 1021 and two diagonally arranged threaded holes 1022 are provided (see FIG. 3). The coding pin holes 1021 serve to receive coding pins 1023 and the threaded holes 1022 serve to receive locking elements 1024, for example, screws. In another embodiment, the front corners of the cover insertion portion form the coding pin holes and the threaded holes if the cover insertion portion 101 is square or rectangular. Here, an inner face of the cover insertion portion 101 is again cylindrical.

The single-pin connector 1 comprises a retaining ring 13 which is formed substantially cylindrical and serves for fixing the contact, i.e., the contact housing 12, in the cover 10. The retaining ring 13 has multiple notches 131 on one side (i.e., on the front side in the plug-in direction PD (see FIG. 2)), which may for example, number two, three, four or any other number, and serve to receive a tool (not shown) for screwing the retaining ring, e.g., an engagement jaw for receiving a tool; on the other side (i.e., on the back in the plug-in direction PD), the retaining ring 13 has a flange 132 with a specific thickness. The flange 132 protrudes radially inward and is configured approximately in the form of a bottom edge of a dish. Between the notches 131 and the flange 132, an external thread portion 133 is provided on the outer face of the retaining ring 13.

Furthermore, the single-pin connector 1 comprises a cable connection 14 for fixing the cable 3 to the connection side of the single-pin connector 1.

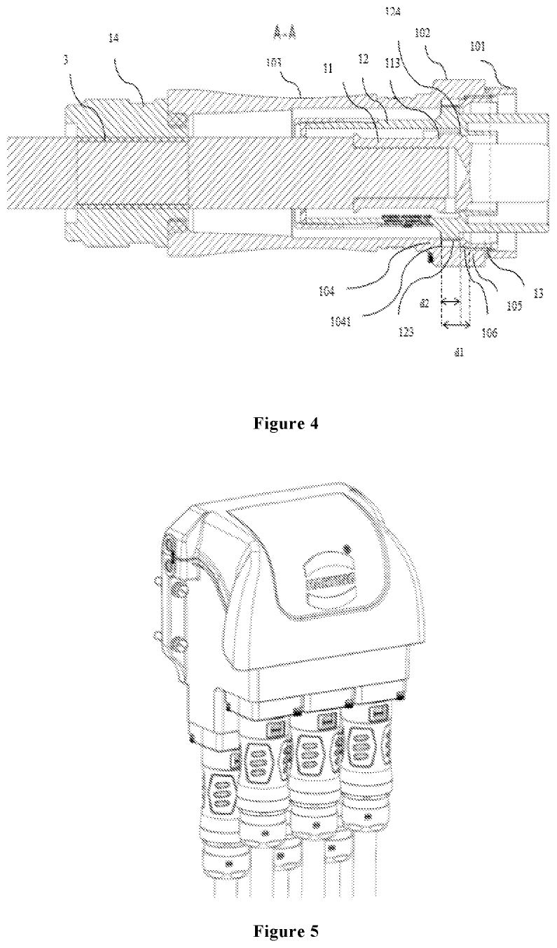

FIG. 4 shows the single-pin connector 1 in a sectional view along section line A-A. The inner face of the cover 10 has an inwardly protruding delimiting portion 104 situated in the region at which the flange portion 102 is arranged and extending from the flange portion region up to the region of the grip 103. The delimiting portion 104 is configured as a step portion, and the end face of the step portion forms a delimiting face 1041. In another embodiment, the delimiting portion 104 may be configured as a delimiting lug, the side of which facing the cover insertion portion 101 is formed as a delimiting face. The delimiting lug may be continuous or interrupted. The inner face of the cover 10 has an internal thread portion 105 which lies closer to the plug side P than the delimiting portion 104. The internal thread portion 105 is also arranged in the region of the flange portion 102 and extends approximately from the connecting point between the flange portion 102 and the cover insertion portion 101 in the direction of the delimiting portion 104. The delimiting portion 104 and the internal thread portion 105 are spaced from one another by a distance d1 which is greater than a width d2 of the delimiting protrusion 123 of the contact housing 12. An additional step portion 106 may be provided between the delimiting portion 104 and the internal thread portion 105. An inner diameter of the delimiting portion 104 is smaller than an inner diameter of the additional step portion 106, and an inner diameter of the additional step portion 106 is smaller than an inner diameter of the internal thread portion 105. The additional step portion 106 is rounded to adapt to the outer form of the flange 132 of the retaining ring.

In another embodiment, the distance d1 between the delimiting portion 104 and the internal thread portion 105 may equal the width d2 of the delimiting portion 123 of the contact housing 12. In this case, the flange 132 of the retaining ring 13 may be configured as a thin annular plate which protrudes radially inward from the rear.

With reference to FIGS. 2 and 4, the mounting of the single-pin connector 1 is described. Firstly, the insulating casing layer and the EMC textile layer on the front end of the cable 3 are removed in order to expose the inner core. Then the cable connection 14 is pushed against the plug-in direction onto the cable 3. The core of the cable is then inserted in the terminal connecting portion 112 of the terminal 11, for example by crimping the terminal connecting portion 112 of the terminal 11 by a crimping tool so that the inner face of the terminal connecting portion 112 is tightly engaged with the core of the cable 3. At the same time, or before or afterwards, the contact housing 12 is inserted in the cover 10 from the plug side P against the plug-in direction until a side of the delimiting protrusion 123 of the contact housing 12 bears against the delimiting portion 104 of the cover, limiting a further movement of the contact housing 12 against the plug-in direction. Then the retaining ring 13 is screwed into the cover 10 against the plug-in direction using a tool. During screwing, the external thread portion 133 of the retaining ring 13 comes into threaded engagement with the internal thread portion 105 of the inner face of the cover 10. Finally, the flange 132 of the retaining ring 13 bears on the other side of the delimiting protrusion 123 of the contact housing 12, fixing the retaining ring 13 and hence, the contact housing 12 in the cover 10. Then the terminal 11 is inserted in the cover 10 from the connection side C in the plug-in direction until the annular flange 113 of the terminal 11 bears on a stop portion 124 of the inner face of the contact housing 12, preventing a forward movement of the terminal 11 in the plug-in direction. Finally, the terminal 11 and the cable 3 are fixed in the cover 10 by engagement of the end of the grip 103 of the cover 10 with the cable connection 14, which completes the mounting of the single-pin connector 1.

FIG. 3 shows a top view of the mounted single-pin connector 1. From inside to outside, this illustrates in this order the terminal 11, the contact housing 12, the retaining ring 13 and the flange portion 102.

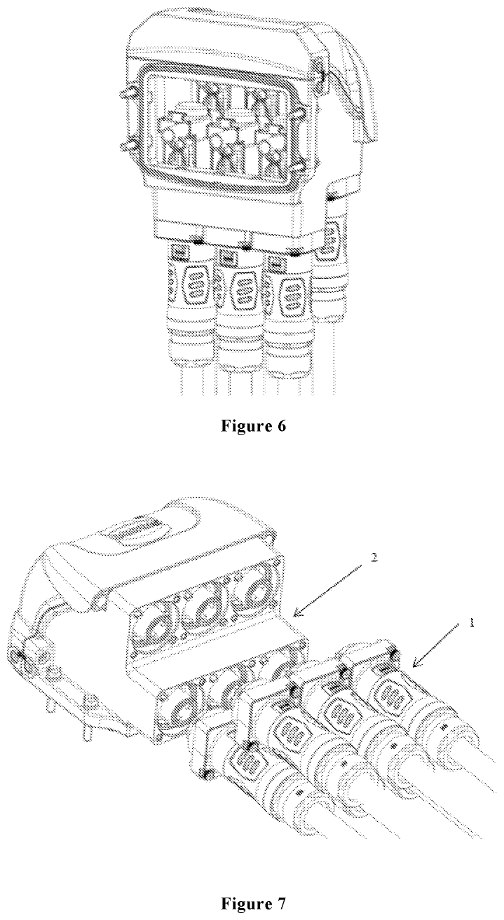

FIGS. 5 to 7 show a connector system which is formed by assembling the single-pin connector 1 with a multi-pin connector 2. The connector system has several, e.g., six single-pin connectors. In another embodiment, the connector system may have one, two, four, six, eight or any other number of single-pin connectors. The six single-pin connectors are attached to the multi-pin connector 2 independently of one another, so that in practical use, single-pin connectors can be installed individually, thereby facilitating mounting.

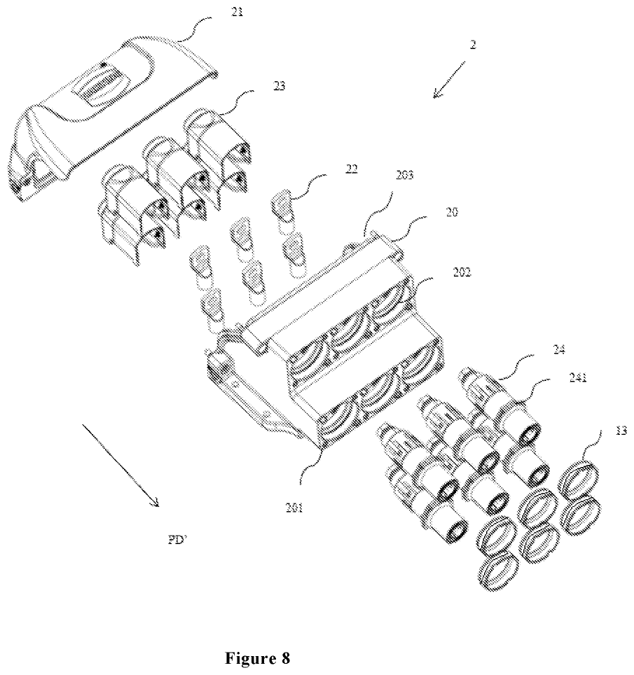

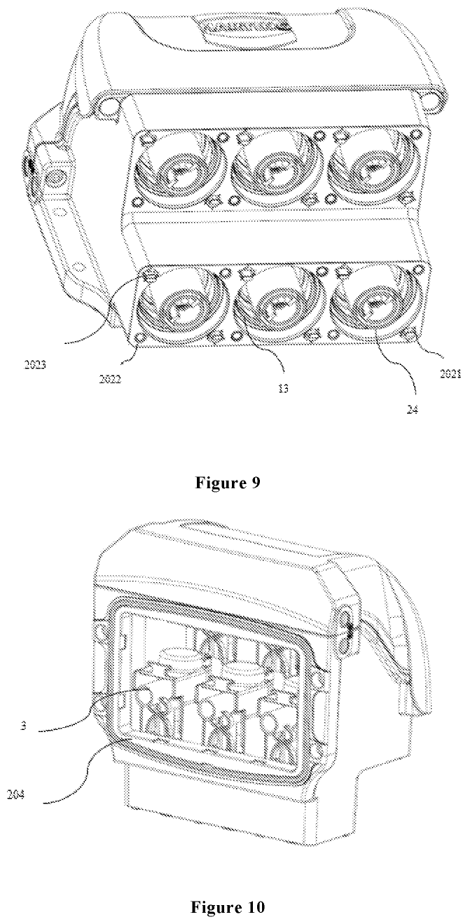

With reference to FIGS. 8 to 10, the multi-pin connector 2 is explained below. The multi-pin connector 2 is formed as a socket connector and may be configured for mounting on a compartment wall of a train. As evident from FIG. 8, the multi-pin connector 2 comprises a passage housing 20, an upper lid 21 and insulating caps 23, cable connections 22, contacts 24 (here as female contacts) and retaining rings 13 which are received in the passage housing.

The passage housing 20 has two substantially rectangular openings 201 which are spaced vertically from one another. Several sockets 202 are arranged at each opening. In another embodiment, the passage housing 20 may alternatively have one opening or another number of openings. In another embodiment, one of the multiple openings may be covered by a cover plate when not in use. A flange of each socket is provided with two diagonally arranged coding pin holes 2021 and two diagonally arranged threaded holes 2022 to receive respectively coding pins 2023 and locking elements 1024 of the flange portion 102 of the single-pin connector 1. The coding pins 2023 of the socket and the coding pins 1023 of the single-pin connector cooperate with one another, which may prevent incorrect connection. When mounting the connector system, the several single-pin connectors may be inserted in their respective sockets independently of one another. The passage housing 20 has an entrance opening 203 which is covered by the upper lid 21. As shown in FIG. 10, the passage housing 20 has a notch 204, the plane of which runs perpendicular to the plane of the opening 201. The notch 204 serves for insertion of the cable 3 and for attachment of the multi-pin connector 2 to a wall of a train compartment.

The number of socket contacts 24 may correspond to the number of sockets 202. The contact 24 is inserted into the socket 202 from the outside against the plug-in direction PD′ until the delimiting protrusion 241 of the contact 24 bears on a delimiting portion (not shown) of the inner face of the socket 202. Then the retaining ring 13 is screwed into the socket 202 so that the external thread portion of the retaining ring comes into engagement with the internal thread portion (not shown) of the socket 202, in order to fix the contact 24 in the socket 202. The several insulating caps 23 cover tails of the contacts 24, and the tail is connected to the cable 3 via the cable connection 22. This completes the mounting of the multi-pin connectors.

It is evident for person skilled in this art that the present invention is in no way restricted to the details of the exemplary embodiments described above, and may be implemented in other concrete forms. Moreover, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A single-pin connector with a plug side for assembly with a counter-connector, and a connection side for connection of a cable, the single-pin connector, comprising:
a contact which has having a contact housing, wherein the contact housing has at least one delimiting protrusion on an outer surface; and
a cover for receiving the contact, wherein an inner surface of the cover has an inwardly protruding delimiting portion and an internal thread portion, wherein the internal thread portion is closer to the plug side than the delimiting portion; and
a retaining ring having an external thread portion,
wherein, after insertion of the contact housing into the cover against a plug-in direction, the retaining ring is screwed into the cover until the at least one delimiting protrusion of the contact housing bears against the delimiting portion of the cover, thereby fixing the contact housing in the cover by a screw connection.

2. The single-pin connector as claimed in claim 1, wherein the retaining ring is cylindrical, wherein a plurality of notches are provided on one side of the retaining ring in order to come into engagement with a tool for screwing in the retaining ring; wherein an inwardly protruding flange is arranged on an other side of the retaining ring in order to bear against the at least one delimiting protrusion of the contact housing; wherein the external thread portion is arranged between the notches and the inwardly protruding flange on an outer circumference of the retaining ring.

3. The single-pin connector as claimed in claim 2, wherein the cover comprises a cover insertion portion, a grip and a flange portion which is arranged between the cover insertion portion and the grip.

4. The single-pin connector as claimed in claim 3, the wherein an inner face of a region of the flange portion comprises the delimiting portion and the internal thread portion,
wherein the delimiting portion is formed as a step portion and an end face of the step portion forms a delimiting face, or
the delimiting portion is configured as a lug, wherein a side of the lug forms a delimiting face,
wherein a distance between the internal thread portion and the delimiting face is greater than or equal to a width of the delimiting protrusion.

5. The single-pin connector as claimed in claim 4, wherein the inner face of the region of the flange portion comprises an additional step portion arranged between the delimiting portion and the internal thread portion, wherein an inner diameter of the delimiting portion is smaller than an inner diameter of the additional step portion, and the inner diameter of the additional step portion is smaller than an inner diameter of the internal thread portion.

6. The single-pin connector as claimed in claim 5, wherein the additional step portion is rounded so as to adapt to an outer form of the flange of the retaining ring.

7. The single-pin connector as claimed in claim 3, wherein the flange portion is square or rectangular, wherein in the corners of the flange portion, two diagonally arranged coding pin holes and two diagonally arranged threaded holes are provided for receiving coding pins and locking elements respectively; or
wherein an outer contour of the cover insert is square or rectangular, wherein in the corners of the cover insert, two diagonally arranged coding pin holes and two diagonally arranged threaded holes are provided for receiving coding pins and locking elements respectively; wherein an inner contour of the cover insert is cylindrical.

8. A multi-pin connector, comprising:
a passage housing, wherein the passage housing has at least one opening and a plurality of sockets arranged at the opening;
a plurality of contacts, wherein each respective contact has at least one delimiting protrusion on an outer face;
wherein an inner face of the socket has an inwardly protruding delimiting portion and an internal thread portion, wherein the multi-pin connector has several retaining rings, each with an external thread portion, wherein after insertion of the contact in the socket against a plug-in direction, each retaining ring is screwed into a respective one of the sockets until the delimiting protrusion bears against the delimiting portion, whereby the contact is fixed in the socket by a screw connection.

9. A connector system, comprising:
a plurality of single-pin connectors as claimed in claim 1; and
a multi-pin connector, wherein the single-pin connectors can be inserted in corresponding sockets of the multi-pin connector independently of one another.

10. The connector system as claimed in claim 9, wherein the single-pin connector is a male connector and the multi-pin connector is a female connector.
